(19) United States
(12) Patent Application Publication
(10) Pub. No.: US 2025/0080258 A1
(43) Pub. Date: Mar. 6, 2025

(54) GEOMETRY-BASED STOCHASTIC CHANNEL MODELING METHOD ORIENTED TO WIRELESS COMMUNICATION IN UNDERGROUND MINE

(71) Applicants: Southeast University, Nanjing (CN); PURPLE MOUNTAIN LABORATORIES, Nanjing (CN)

(72) Inventors: Chengxiang WANG, Nanjing (CN); Xingyu JI, Nanjing (CN); Hengtai CHANG, Nanjing (CN)

(21) Appl. No.: 18/819,202

(22) Filed: Aug. 29, 2024

(30) Foreign Application Priority Data
Aug. 29, 2023 (CN) 202311091928.0

(51) Int. Cl. H04B 17/391; H04B 17/336

(52) U.S. Cl. CPC H04B 17/3911; H04B 17/336; H04B 17/3912

(57) ABSTRACT

The present disclosure discloses a geometry-based stochastic channel modeling method oriented to a wireless communication in an underground mine. The geometry-based stochastic channel modeling method generates basic parameters such as an environment and antennas; generates a three-dimensional time-varying twin-cluster channel environment, that is, a number, a distance and an angle distribution of the clusters, and the like; derives channel parameters such as a position distribution of scatterers, and a power distribution of the scatterers in the clusters; introduces a roughness of a wall and characterizes an influence caused by the rough wall from two aspects of a phase variation and an energy attenuation according to angle parameters, calculates a time-varying channel impulse response and a channel matrix, and implements a simulation channel model and analyzes a statistical characteristic of a channel. The present disclosure adopts a geometry-based stochastic channel modeling method to establish an underground mine channel model, which considers a unique channel characteristic of the rough wall and has a relatively high accuracy, a moderate complexity, and a better universality, and the statistical characteristic of the simulation has a reference value for the design for the communication system in the underground mine.

### TECHNICAL FIELD

The present disclosure belongs to the field of channel modeling, and in particular relates to a geometry-based stochastic channel modeling method oriented to a wireless communication in an underground mine.

### BACKGROUND

The sixth generation (6G) mobile communication system will be continued to deepen mobile internet on the basis of 5G communication system, which continuously expands the boundary and the scope of the Internet of Everything, and implements the intelligent connection of everything. 6G will implement the deep global coverage based on the local coverage on the land which expands to the integrated communication network of air, space, ground and ocean, including the underground communication network, the satellite communication network, the aviation communication network, and the maritime communication network. As a typical underground scenario, the underground mine has a plurality of unique channel characteristics, such as the rough wall.

The wall roughness is generally introduced to characterize the influence of the rough wall on underground wireless channels. The roughness is defined as the variation in the tunnel wall height relative to the average surface level. For the rough surface, the incident energy will be scattered at a non-specular angle.

A quantity of studies exists on the influence of the rough wall. For example, the literature (Ray tracing and modal methods for modeling radio propagation in tunnels with rough walls) deduces a general analytical formula for solving the surface roughness through the modal method and the ray tracing method, which proves the equivalence of the two methods through the mathematical method. The literature (Ray tracing-based wireless channel modeling in room-and-pillar mines) utilizes the ray tracing method and the contour correction modeling method to conduct a study on the room-and-pillar underground mine considering the wall roughness, and simulates the statistical characteristics such as the time delay spread. However, as a deterministic modeling method, the ray tracing has a high accuracy, but it also commonly faces the complex issues.

Geometry-based stochastic channel modeling can directly generate the channel coefficients, and can easily fit the measurement data by adjusting the parameters, which has a moderate complexity and a relatively high versatility and accuracy. Currently, there are many studies on the geometry-based stochastic channel models in the high-speed train tunnel scenario. However, despite some similarities between the underground mine and the tunnel, the underground mine has the unique channel characteristics such as the rough wall. Therefore, the geometry-based stochastic channel model for the tunnel scenario is not directly suitable for direct application in the underground mine.

In summary, it is extremely necessary to establish a better geometry-based stochastic channel model for the underground mine with a good balance among the accuracy, the universality, and the complexity at present.

### SUMMARY

The objectives of the present disclosure are to provide a geometry-based stochastic channel modeling method oriented to a wireless communication in an underground mine, which considers an influence caused by a rough wall in the mine, and establishes an accurate, moderately complex, and more universal geometry-based stochastic channel model for the wireless communication in the underground mine.

In order to achieve the above objectives, the following technical solutions are adopted in the present disclosure.

Provided is a geometry-based stochastic channel modeling method oriented to a wireless communication in an underground mine, the method comprises following steps.

In Step S1, basic parameters for an environment and antennas are generated.

In Step S2, a three-dimensional time-varying twin-cluster channel environment is generated, specifically the three-dimensional time-varying twin-cluster channel environment includes positions of the clusters and angle parameters, distance parameters, and power parameters for scatterers.

In Step S3, a wall roughness is introduced, and an influence caused by a rough wall is characterized from two aspects of a phase variation and an energy attenuation according to the angle parameters.

In Step S4, a time-varying channel impulse response and a channel matrix are calculated, the time-varying channel impulse response includes a line-of-sight (LoS) component and a non-LoS (NLoS) component.

In Step S5, a space-time-frequency correlation function and a channel capacity are calculated and obtained according to the channel matrix established in Step S4.

Preferably, Step S1 specifically includes following steps.

The basic parameters include a frequency band, antenna parameters, and a simulation time required for a scenario of the underground mine.

Large-scale fading parameters for the channel are determined based on a frequency band, antenna parameters and a simulation time required for a scenario of the underground mine, and the large-scale fading parameters includes a path loss and a shadow fading.

Preferably, Step S2 specifically includes following steps.

In Step S201, a twin-cluster channel model is adopted, and a uniform linear array is adopted for antennas at transmitter, and the antennas at transmitter are arbitrarily placed in a three-dimensional space.

In Step S202, the positions of the clusters are generated, and a cluster distance d̅, a horizontal angle ϕ̅_{A} and an elevation angle ϕ̅_{E} obey following distributions,

$$\overline{d} ∼ N ( u , σ ) ,$$

$${\overline{ϕ}}_{A} = ASA * N ( 0 , 1 ) + {β}_{A}^{T} ,$$

$${\overline{ϕ}}_{E} = ESA * N ( 0 , 1 ) + {β}_{E}^{T} ,$$

where (d̅, ϕ̅_{A}, ϕ̅_{E}) denotes a spherical coordinate of the cluster, N(μ, σ) denotes a Gaussian distribution with a mean value of μ and a variance of σ, azimuth spread of arrival (ASA) and elevation spread of arrival (ESA) denote standard documents of 3GPP, β_{A}^{T} denotes a horizontal angel of a placed antenna at transmitter, and β_{E}^{T} denotes an evaluation angle of the placed antenna at transmitter.

Step S203, positions of the scatterers are generated, a scatterer distribution in the cluster is modeled as a Gaussian ellipsoid distribution, and the scatterer distribution is described through a Cluster Angular Spread σ_{AS}, a Cluster Elevation Spread σ_{ES} and a Cluster Delay Spread σ_{DS}, the scatterers are in a rectangular coordinate system with a cluster center as a coordinate origin, and a distribution probability p(x′, y′, z′) of the scatterers located at (x′, y′, z′) is as follows:

$$p ( {x}^{′} , {y}^{′} , {z}^{′} ) = \frac{exp ( - \frac{{x}^{{′}^{2}}}{2 {σ}_{DS}^{2}} - \frac{{y}^{{′}^{2}}}{2 {σ}_{AS}^{2}} - \frac{{z}^{{′}^{2}}}{2 {σ}_{ES}^{2}} )}{{( 2 π )}^{3 / 2} {σ}_{DS} {σ}_{AS} {σ}_{ES}} .$$

In Step 204, the power of the scatterer is derived, specifically a position (dₘ_{ₙ}^{T}, ∅_{A,m}_{ₙ}^{T}, ∅_{E,m}_{ₙ}^{T}) of the scatterer in the three-dimensional space is determined based on the distribution probability of the scatterer, a propagation time delay corresponding to a m-th scatter in a n-th cluster, that is, the propagation time delay τ_{qp,m}_{ₙ}(t) corresponding to a mₙ-th sub-path is as follows:

$${τ}_{pq , {m}_{n}} ( t ) = \frac{{d}_{pq , {m}_{n}} ( t )}{c} + {\tilde{τ}}_{{m}_{n}} ,$$

where d_{pq,m}_{ₙ}(t) denotes a transmission distance of the mₙ-th sub-path, \tilde{τ}ₘ_{ₙ} denotes a time delay at a virtual link, which obeys an exponential distribution, d_{pq,m}_{ₙ}(t) is calculated by a formula of d_{pq,m}_{ₙ}(t)=∥\vec{d}_{p,m}_{ₙ}^{T}(t)∥+∥\vec{d}_{q,m}_{ₙ}^{R}(t)∥, ∥\vec{d}_{p,m}_{ₙ}^{T}(t)∥ denotes a transmission distance from a p-th antenna at transmitter to the m-th scatterer in the n-th cluster, ∥\vec{d}_{q,m}_{ₙ}^{R}(t)∥ denotes a transmission distance from a q-th antenna at receiver to the m-th scatterer in the n-th cluster, a superscript arrow “→” denotes a vector, and “∥*∥” denotes a norm.

Under wide-sense stationary and plane wave conditions, ∥\vec{d}_{p,m}_{ₙ}^{T}(t)∥ is calculated by a formula of ∥\vec{d}_{p,m}_{ₙ}^{T}(t)∥=d_{p,m}_{ₙ}^{T}(t)≈dₘ_{ₙ}^{T}−cos(ϑ^{T}ₘ_{ₙ})δₚ−cos(ω^{T}ₘ_{ₙ})ν^{T}(t)t, dₘ_{ₙ}^{T} denotes a transmission distance from a first antenna at transmitter to the m-th scatterer in the n-th cluster, δₚ denotes a spacing between the antennas at transmitter, ϑ^{T}ₘ_{ₙ} denotes an included angle between a transmitting antenna array and the mₙ-th sub-path of the first antenna at transmitter, ω^{T}ₘ_{ₙ} denotes an included angel between a motion direction of the transmitter and the mₙ-th sub-path of the p-th antenna at transmitter, cos(ϑ^{T}ₘ_{ₙ}) is calculated by a formula of cos(ϑ^{T}ₘ_{ₙ})=cos(∅_{E,m}_{ₙ}^{T})cos(β_{E}^{T})cos(β_{A}^{T}−∅_{A,m}_{ₙ}^{T})+sin(∅_{E,m}_{ₙ}^{T})sin(β_{E}^{T}), cos(ω^{T}ₘ_{ₙ}) is calculated by a formula of cos(ω^{T}ₘ_{ₙ})=cos(α^{T}−∅_{A,m}_{ₙ}^{T})cos(∅_{E,m}_{ₙ}^{T}), ∅_{A,m}_{ₙ}^{T} denotes a horizontal departure angle corresponding to the mₙ-th sub-path, ∅_{E,m}_{ₙ}^{T} denotes an elevation departure angle corresponding to the mₙ-th sub-path, β_{A}^{T} denotes a horizontal angle of the placed transmitting antenna, and β_{E}^{T} denotes an elevation angle of the placed transmitting antenna.

Assuming that the antenna at transmitter are motioned in a xoy plane, then ν^{T}(t) denotes a motion velocity of the antenna at transmitter, and α^{T} denotes a motion direction.

Then a power distribution P′_{pq,m}_{ₙ}(t) of a sub-path in the cluster is as follows:

$${P}_{pq , {m}_{n}}^{′} ( t ) = exp ( - {τ}_{pq , {m}_{n}} ( t ) \frac{{r}_{τ} - 1}{{r}_{τ} DS} ) 1 {0}^{- \frac{{Z}_{n}}{10}} \cdot {ξ}_{n} ( p , q ) ,$$

where DS denotes a time delay spread, r_{τ} denotes a factor of a time delay distribution proportionality, the two parameters of DS and r_{τ} are given by the 3GPP standardized document, Zₙ denotes a Gaussian random variable with a mean value of 0, and ξₙ(p, q) denotes a variation coefficient of a power of the cluster along the array.

In Step S205, the power distribution P′_{pq,m}_{ₙ}(t) of the sub-path in the cluster is normalized, and the P′_{pq,m}_{ₙ}(t) is calculated as follows:

$${P}_{pq , {m}_{n}} ( t ) = {P}_{pq , {m}_{n}}^{′} ( t ) / {\sum }_{n = 1}^{{N}_{pq} ( t )} {\sum }_{m = 1}^{{M}_{n} ( t )} {P}_{pq , {m}_{n}}^{′} ( t ) ,$$

where N_{pq}(t) denotes a number of clusters passing between the p-th antenna at transmitter and the q-th antenna at receiver, and Mₙ(t) denotes a number of scatterers in the cluster.

Preferably, assuming that the wall roughness, that is, a height difference between a rough surface and a smooth surface is Δh, and the height difference Δh obeys the Gaussian distribution with the mean value of 0, and a standard difference is δₕ, that is, Δh˜N(0, δₕ²), compared with a smooth surface, a phase difference Δφ caused by the rough surface is as follows:

$$Δφ = 2 k Δ h sin α ,$$

where

$$k = \frac{2 π}{λ}$$

denotes a wave number and α denotes an included angle between an incident ray and a horizontal plane.

In addition, a loss of a signal energy is further caused by the rough surface, and a roughness attenuation factor ρₛ caused by the rough surface is as follows:

$${ρ}_{s} = exp \{ - 8 {( \frac{π {δ}_{h} cos θ}{λ} )}^{2} \} ,$$

where θ denotes an included angle between the incident ray and a surface normal.

Preferably, in Step S4, the channel matrix H is expressed as follows:

$$H = {[ {h}_{pq} ( t , τ ) ]}_{{m}_{T} \times {m}_{R}} ,$$

where m_{T} denotes a number of the antennas at transmitter, m_{R} denotes a number of the antennas at receiver, h_{pq}^{N}(t, τ) denotes a time-varying channel impulse response, and an expression of h_{pq}^{N}(t, τ) is as follow:

$${h}_{pq} ( t , τ ) = \sqrt{\frac{K}{K + 1}} {h}_{pq}^{L} ( t , τ ) + \sqrt{\frac{1}{K + 1}} {h}_{pq}^{N} ( t , τ ) ,$$

where, K denotes a Rice factor, h_{pq}^{L}(t, τ) denotes a LoS component, and h_{pq}^{N}(t, τ) denotes a NLoS component.

An expression of the LoS component h_{pq}^{L}(t, τ) is as follows:

$${h}_{pq}^{L} ( t , τ ) = {e}^{j 2 π {f}_{c} {τ}_{pq}^{L} ( t )} \cdot δ ( τ - {τ}_{pq}^{L} ( t ) ) .$$

Expressions of the NLoS component h_{pq}^{N}(t, τ) are as follow:

$${h}_{p q}^{N} ( t , τ ) = {\sum }_{n = 1}^{{N}_{pq} ( t )} {\sum }_{m = 1}^{{M}_{n} ( t )} {h}_{pq , {m}_{n}}^{N} ( t , τ ) ,$$

$${h}_{pq , {m}_{n}}^{N} ( t , τ ) = \sqrt{{P}_{pq , {m}_{n}} ( t )} {e}^{j 2 π {f}_{c} {τ}_{pq , {m}_{n} ( t )}} \cdot δ ( τ - {τ}_{pq , {m}_{n}} ( t ) ) ,$$

where Aₚ^{T} denotes the p-th antenna at transmitter, A_{q}^{R} denotes a q-th antenna at receiver, f_{c} denotes a carrier frequency, τ_{pq}^{L}(t) denotes a time delay at a LoS path between Aₚ^{T} and A_{q}^{R}, N_{pq}(t) denotes a number of clusters of a path between Aₚ^{T} and A_{q}^{R}, and Mₙ(t) denotes a number of scatterers in the n-th cluster.
τ_{pq,m}_{ₙ}(t) denotes a time delay of the mₙ-th sub-path, and P_{pq,m}_{ₙ}(t) denotes a power of a m-th scatterer in the n-th cluster between Aₚ^{T} and A_{q}^{R}.

When the wall surface is rough, a LoS component is not reflected through the rough surface, so the channel impulse response of the LoS component remains unvaried with respect to roughness; for an arbitrary ray of NLoS paths, assuming that the ray experiences reflections for kₘ_{ₙ} times, the phase difference caused by the rough surface is

$${Δφ}_{{m}_{n}} = {Δφ}_{1} + {Δφ}_{2} + … + {Δφ}_{{k}_{{m}_{n}}} ,$$

and an attenuation of the signal energy is

$${{ρ}_{s}}^{{k}_{{m}_{n}}} ,$$

therefore the channel impulse response of the NLos component is modified as

$${h}_{pq , {m}_{n} ( new )}^{N} ( t , τ ) = {h}_{pq , {m}_{n}}^{N} ( t , τ ) \cdot {e}^{j {Δφ}_{{m}_{n}}} \cdot {{ρ}_{s}}^{{k}_{{m}_{n}}} .$$

Preferably, the Step S5 specifically includes following steps.

The time-varying channel impulse response h_{pq}(t, τ) is transformed through a Fourier transform to obtain a channel transmission function, the channel transmission function is expressed as H(t, f)=∫₀^{∞}h(t, τ)e^{-j2πfτ}dτ, and the space-time-frequency correlation function

$${R}_{pq , \tilde{p} \tilde{q}} ( t , f ; Δ r , Δ t , Δ f )$$

is further expressed as follows:

$${R}_{pq , \tilde{p} \tilde{q}} ( t , f ; Δ r , Δ t , Δ f ) = E \{ {H}_{pq} ( t , f ) {H}_{\tilde{p} \tilde{q}}^{T} ( t - Δ t , f - Δ f ) \} ,$$

where E{⋅} denotes an expectation, {⋅}^{T} denotes a transposition, H_{pq}(t, f) denotes a channel transmission function between the p-th antenna at transmitter and the q-th antenna at receiver, and Δr, Δt, Δf are interval parameters in space, time, and frequency domains.

The channel capacity C is as follows:

$$C = E \{ {log}_{2} ( 1 + \frac{ρ}{{m}_{T}} {HH}^{*} ) \} ,$$

where ρ denotes a signal-to-noise ratio, and {⋅}* denotes a conjugate transposition.

Beneficial effects lie in the following.

The geometry-based stochastic channel modeling method oriented to the wireless communication in the underground mine provided in the present disclosure has the following advantages.
1. Compared with the ray tracing model, the present disclosure has a higher accuracy and has an appropriate complexity.
2. The present disclosure considers the influence caused by the rough wall in the underground mine, which is more consistent with the actual situations, and has a higher universality.

### BRIEF DESCRIPTION OF THE DRAWINGS

FIG. 1 illustrates a schematic flow chart of a geometry-based stochastic channel modeling method oriented to a wireless communication for an underground mine provided in Embodiment 1.

FIG. 2 illustrates a schematic diagram of a Multiple-Input Multiple-Output (MIMO) channel model for a three-dimensional underground mine based on a geometry-based stochastic provided in Embodiment 1.

FIG. 3 illustrates a schematic diagram of a simulation result for a time self-correlation provided in Embodiment 1.

FIG. 4 illustrates a schematic diagram of a simulation result for a spatial cross-correlation provided in Embodiment 1.

FIG. 5 illustrates a schematic diagram of a simulation result for a channel capacity provided in Embodiment 1.

### DETAILED DESCRIPTION OF THE EMBODIMENT

In order to better understand the objectives, the structures and the functions of the present disclosure, a geometry-based stochastic channel modeling method oriented to a wireless communication in an underground mine provided in the present disclosure will be described in further detail below with reference to the accompanying drawings. It will be apparent that the described embodiments are only a part of the embodiments of the present disclosure, but not all of the embodiments. Based on the embodiments of the present disclosure, all other embodiments obtained by those of ordinary skill in the art without any creative efforts shall fall within the protection scope of the present disclosure.

### Embodiment 1

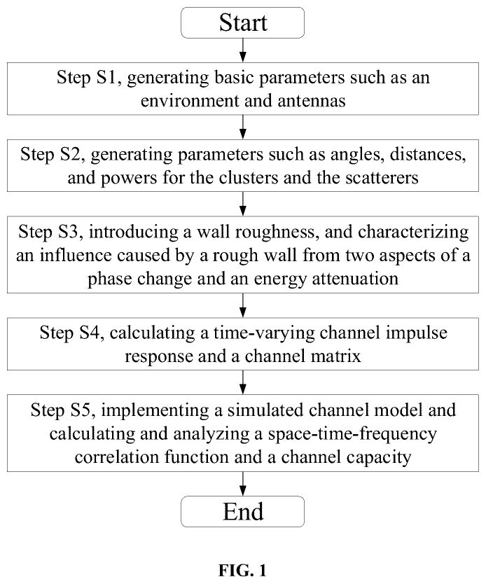

As illustrated in FIGS. 1 to 5, a geometry-based stochastic channel modeling method oriented to a wireless communication in an underground mine is provided in this embodiment. The channel modeling method includes the following steps.

In Step 1, the basic parameters for the environment and the antennas are generated.

Specifically, in this embodiment, the model utilizes a geometry-based stochastic channel model (GBSM) method to determine that a distance between a base station and a user is 200 m, a system frequency is 5.8 GHz, a spacing between the antennas at transmitter and a spacing between the antennas at receiver are all a half wavelength, elevation angles of the transceiving antenna arrays are π/2, and horizontal angles of the transceiving antenna arrays are 0, motion velocities of the base station and the user are all 10 m/s, and motion directions of the base station and the user are a direction of the elevation angle of 0 and the horizontal angle of 0, and the omnidirectional antennas with vertical polarization are adopted in the transmitting antennas and the receiving antennas.

The large-scale fading parameters for the channel, that is a path loss PL and a shadow fading SF, are determined based on the above parameters.

In Step 2, a three-dimensional time-varying twin-cluster channel environment is generated. Specifically, the three-dimensional time-varying twin-cluster channel environment includes the angle parameters, the distance parameters, and the power parameters for the clusters and the scatterers.

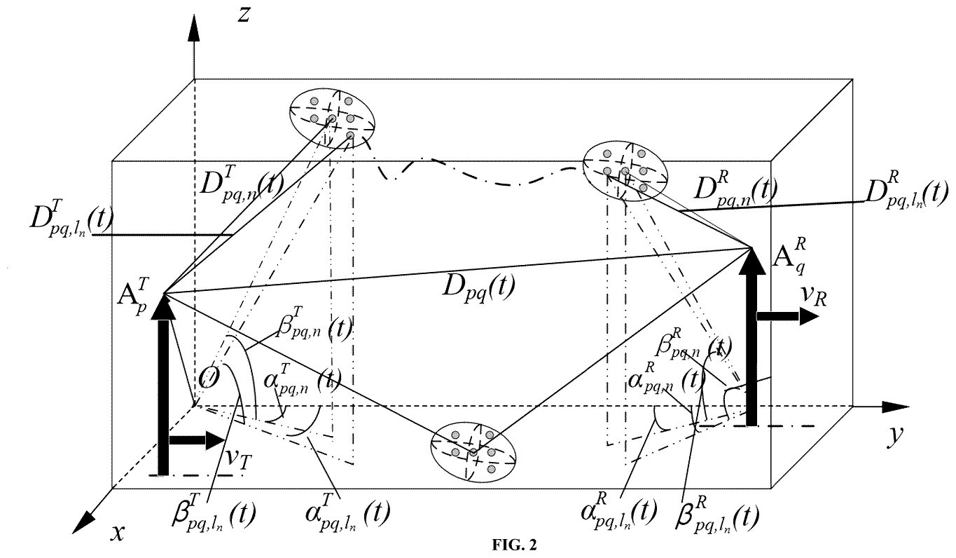

Specifically, in this embodiment, a twin-cluster channel model is adopted in the model, and the specific channel model is as illustrated in FIG. 2.

A uniform linear array is adopted at the antenna terminal, and the antenna terminal can be placed arbitrarily in the three-dimensional space. For simplicity, merely the n-th cluster (n=1, . . . , N_{pq}(t)) is illustrated in the figure. The n-th path is expressed by a pair of clusters, that is, Cₙ^{A} at the transmitter and Cₙ^{Z} at the receiver. N_{pq}(t) denotes a number of the clusters between the p-th transmitting antenna (p=1, . . . , mT) and the q-th receiving antenna (q=1, . . . , mR) at the time instant t, Mn(t) denotes a number of the rays included in the n-th cluster. A propagation between Cₙ^{A} and Cₙ^{Z} is expressed by a virtual link with a given delay. When a time delay of the virtual link is set as 0, the twin-cluster model is simplified to a single-cluster model.

More specifically, in this embodiment, the generating a three-dimensional time-varying twin-cluster channel environment specifically includes the following steps.

In Step 201, the positions of the clusters are generated.

Since the transceiver have the reciprocity, the generation of the clusters at transmitter is taken as an example, the distance, the horizontal angel and the elevation angle for the clusters obey the following distributions:

$$\overline{d} ∼ N ( u , σ ) ,$$

$${\overline{ϕ}}_{A} = ASA * N ( 0 , 1 ) + {β}_{A}^{T} ,$$

$${\overline{ϕ}}_{E} = ESA * N ( 0 , 1 ) + {β}_{E}^{T} ,$$

where (d̅, ϕ̅_{A}, ϕ̅_{E}) denotes a spherical coordinate of the cluster, N(μ, σ) denotes a Gaussian distribution with a mean value of μ and a variance of σ, ASA and ESA denote the corresponding angle spread values in the large-scale parameters with the spatial consistency in the 3rd generation partnership project (3GPP) standard channel, β_{A}^{T} denotes a horizontal angel of the placed antenna at transmitter, and β_{E}^{T} denotes an elevation angel of the placed antenna at transmitter.

In Step 202, the positions of the scatterers are generated.

Based on a quantity of the measurement results, the scatterer distributions in the clusters are modeled as a Gaussian ellipsoid distribution, the cluster azimuth spread (CAS) σ_{AS}, the cluster elevation spread (CES) σ_{ES} and the cluster delay spread (CDS) σ_{DS} are utilized to describe the scatterer distribution situation.

The scatterers are in a Cartesian coordinate system with a cluster center as a coordinate origin, and a distribution probability of the scatterers located at (x′, y′, z′) is as follows:

$$p ( {x}^{′} , {y}^{′} , {z}^{′} ) = \frac{exp ( - \frac{{x}^{′ 2}}{2 {σ}_{DS}^{2}} - \frac{{y}^{′ 2}}{2 {σ}_{AS}^{2}} - \frac{{z}^{′ 2}}{2 {σ}_{ES}^{2}} )}{{( 2 π )}^{3 / 2} {σ}_{DS} {σ}_{AS} {σ}_{ES}}$$

In Step 203, the powers of the scatterers are derived.

The positions of the scatterers in the three-dimensional space are determined as (dₘ_{ₙ}^{T}, ∅_{A,m}_{ₙ}^{T}, ∅_{E,m}_{ₙ}^{T}), according to the above formula. The propagation time delay τ_{qp,m}_{ₙ}(t) corresponding to the m-th scatter in the n-th cluster can be expressed as follows:

$${τ}_{pq , {m}_{n}} ( t ) = \frac{{d}_{p q , {m}_{n}} ( t )}{c} + {\tilde{τ}}_{{m}_{n}} ,$$

where d_{pq,m}_{ₙ}(t) is calculated by a formula of d_{pq,m}_{ₙ}(t)=∥\vec{d}_{p,m}_{ₙ}^{T}(t)∥+∥\vec{d}_{q,m}_{ₙ}^{R}(t)∥, \tilde{τ}ₘ_{ₙ} denotes a time delay at the virtual link, which obeys the exponential distribution. Under wide-sense stationary and plane wave conditions, ∥\vec{d}_{p,m}_{ₙ}^{T}(t)∥ is calculated by ∥\vec{d}_{p,m}_{ₙ}^{T}(t)∥=d_{p,m}_{ₙ}^{T}(t)≈dₘ_{ₙ}^{T}−cos(ϑ^{T}ₘ_{ₙ})δₚ−cos(ω^{T}ₘ_{ₙ})ν^{T}(t)t, δₚ denotes a spacing among the antennas at transmitter, cos(ϑ^{T}ₘ_{ₙ}) is calculated by a formula of cos(ϑ^{T}ₘ_{ₙ})=cos(∅_{E,m}_{ₙ}^{T})cos(β_{E}^{T})cos(β_{A}^{T}−∅_{A,m}_{ₙ}^{T})+sin(∅_{E,m}_{ₙ}^{T})sin(β_{E}^{T}), cos(ω^{T}ₘ_{ₙ}) is calculated by a formula of cos(ω^{T}ₘ_{ₙ})=cos(α^{T}−∅_{A,m}_{ₙ}^{T})cos(∅_{E,m}_{ₙ}^{T}), ∅_{A(E),m}_{ₙ}^{T} denotes a horizontal (elevation) departure angle corresponding to the mₙ-th sub-path, β_{A}^{T} denotes a horizontal angle of the placed transmitting antenna, and β_{E}^{T} denotes an elevation angle of the placed transmitting antenna, assuming that the antenna at transmitter is motioned in the xoy plane, then ν^{T}(t) denotes a motion velocity of the antenna at transmitter, and α^{T} denotes a motion direction.

The power distribution of the sub-paths in the cluster can be expressed as follows:

$${P}_{pq , {m}_{n}}^{′} ( t ) = exp ( - {τ}_{pq , {m}_{n}} ( t ) \frac{{r}_{τ} - 1}{{r}_{τ} DS} ) {10}^{\frac{{z}_{n}}{10}} \cdot {ζ}_{n} ( p , q ) ,$$

where DS denotes a time delay spread and r_{τ} denotes a factor of a time delay distribution proportionality, the two parameters of DS and r_{τ} are given by the 3GPP standardized document, Zₙ denotes a Gaussian random variable with a mean value of 0, which is utilized to model a shadow fading of each cluster, and ξₙ(p, q) denotes a variation coefficient of the power of the cluster along the array.

Eventually, the power of the cluster is normalized as follows:

$${P}_{pq , {m}_{n}} ( t ) = {P}_{pq , {m}_{n}}^{′} ( t ) / {\sum }_{n = 1}^{{N}_{pq} ( t )} {\sum }_{m = 1}^{{M}_{n} ( t )} {P}_{pq , {m}_{n}}^{′} ( t ) ,$$

where N_{pq}(t) denotes a number of clusters passing between the p-th antenna at transmitter and the q-th antenna at receiver, and Mₙ(t) denotes a number of scatterers in the cluster.

In Step 3, a wall roughness is introduced, and an influence caused by the rough wall is characterized from two aspects of a phase variation and an energy attenuation based on the angle parameters.

In this embodiment, Step 3 specifically includes the following steps.

Assuming that a height difference of the rough surface is Δh, a wall surface variation obeys a zero-mean Gaussian distribution, and a standard difference is δₕ (that is, Δh˜N(0, δₕ²)), then compared with a smooth surface, a phase difference caused by the rough surface is as follows:

$$Δφ = 2 k Δ hsin α ,$$

where

$$k = \frac{2 π}{λ}$$

denotes a wave number, and α denotes an included angle between an incident ray and a horizontal plane.

A loss of a signal energy is further caused by the rough surface, and a roughness attenuation factor caused by the rough surface is as follows:

$${ρ}_{s} = exp \{ - 8 {( \frac{π {δ}_{h} cos θ}{λ} )}^{2} \} ,$$

where θ denotes an included angle between the incident ray and the surface normal.

In Step 4, a time-varying channel impulse response and a channel matrix are calculated, the time-varying channel impulse response includes a LoS component and a NLoS component. In this embodiment, the channel matrix is as follows:

$$H = {[ {h}_{pq} ( t , τ ) ]}_{{m}_{T} \times {m}_{R}} ,$$

where m_{T} denotes a number of the antennas at transmitter, and m_{R} denotes a number of the antennas at receiver, h_{pq}(t, τ) denotes a time-varying channel impulse response, and an expression of h_{pq}(t, τ) is as follows:

$${h}_{pq} ( t , τ ) = \sqrt{\frac{K}{K + 1}} {h}_{pq}^{L} ( t , τ ) + \sqrt{\frac{1}{K + 1}} {h}_{pq}^{N} ( t , τ ) ,$$

where K denotes a Rice factor, h_{pq}^{L}(t, τ) denotes a LoS component, and h_{pq}^{N}(t, τ) denotes a NLoS component.

An expression for the LoS component h_{pq}^{L}(t, τ) is as follows:

$${h}_{pq}^{L} ( t , τ ) = {e}^{j 2 π {f}_{c} {τ}_{pq}^{L} ( t )} \cdot δ ( τ - {τ}_{pq}^{L} ( t ) ) .$$

Expressions for the NLoS component h_{pq}^{N}(t, τ) are as follows:

$${h}_{pq}^{N} ( t , τ ) = {\sum }_{n = 1}^{{N}_{pq} ( t )} {\sum }_{m = 1}^{{M}_{n} ( t )} {h}_{pq , {m}_{n}}^{N} ( t , τ ) ,$$

$${h}_{pq , {m}_{n}}^{N} ( t , τ ) = \sqrt{{P}_{pq , {m}_{n}} ( t )} {e}^{j 2 π {f}_{c} {τ}_{pq , {m}_{n}} ( t )} \cdot δ ( τ - {τ}_{pq , {m}_{n}} ( t ) ) ,$$

where Aₚ^{T} denotes a p-th antenna at transmitter, A_{q}^{R} denotes a q-th antenna at receiver, f_{c} denotes a carrier frequency, τ_{pq}^{L}(t) denotes a time delay at a LoS path between Aₚ^{T} and A_{q}^{R}, N_{pq}(t) denotes a number of clusters of a path between Aₚ^{T} and A_{q}^{R}, and Mₙ(t) denotes a number of scatterers in the n-th cluster.

τ_{pq,m}_{ₙ}(t) denotes a time delay of a mₙ-th sub-path, and P_{pq,m}_{ₙ}(t) denotes a power of a m-th scatterer in a n-th cluster between Aₚ^{T} and A_{q}^{R}.

When the surface is rough, the LoS component is not reflected through the rough surface, so the channel impulse response of the LoS component remains unvaried. For an arbitrary ray of NLoS paths, assuming that the ray experiences the reflections for kₘ_{ₙ} times, a phase difference is

$${Δφ}_{{m}_{n}} = {Δφ}_{1} + {Δφ}_{2} + … + {Δφ}_{{k}_{{m}_{n}}} ,$$

a signal energy attenuation is

$${{ρ}_{s}}^{{k}_{{m}_{n}}} ,$$

therefore, the channel impulse response of the NLoS component is modified as

$${h}_{pq , {m}_{n} ( new )}^{N} ( t , τ ) = {h}_{pq , {m}_{n}}^{N} ( t , τ ) \cdot {e}^{j {Δφ}_{{m}_{n}}} \cdot {{ρ}_{s}}^{{k}_{{m}_{n}}} .$$

In Step S5, a space-time-frequency correlation function and a channel capacity are calculated and obtained according to the channel matrix established in Step S4.

Specifically, in this embodiment, a simulated channel model is implemented and a statistical characteristics analysis is performed, mainly by means of transforming the time-varying channel impulse response through a Fourier transform to obtain a channel transmission function, an expression for the channel transmission function is H(t, f)=∫₀^{∞}h(t, τ)e^{-j2πfτ}dτ, further an expression for the space-time-frequency correlation function is as follow:

$${R}_{qp , \tilde{q} \tilde{p}} ( t , f ; Δ r , Δ t , Δ f ) = E \{ {H}_{pq} ( t , f ) {H}_{\tilde{p} \tilde{q}}^{*} ( t - Δ t , f - Δ f ) \} ,$$

where E{⋅} denotes an expectation, H_{pq}(t, f) denotes a channel transmission function between the p-th antenna at transmitter and the q-th antenna at receiver.

The formula for calculating the channel capacity is as follows:

$$C = E \{ {log}_{2} ( 1 + \frac{ρ}{{m}_{T}} {HH}^{*} ) \} ,$$

where ρ denotes a signal-to-noise ratio, and {⋅}* denotes a conjugate transposition.

In order to verify the correctness of the method provided in this embodiment, the experiments are performed, which is specifically as follows.

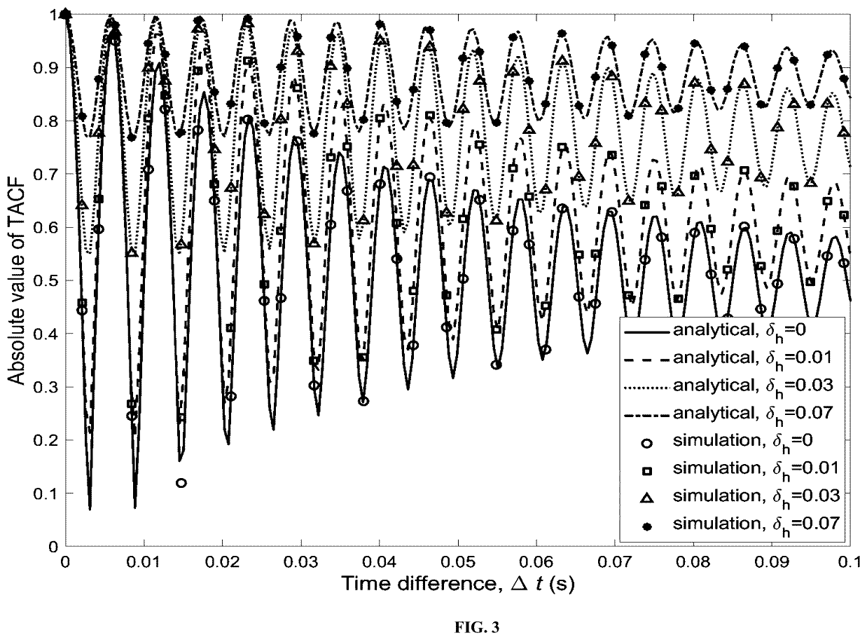

The time correlation of the channels having different wall roughness is studied, and the result for the time correlation is as illustrated in FIG. 3. As the wall roughness increases, the fluctuation of the time correlation function becomes smaller, and the absolute value eventually tends to 1.

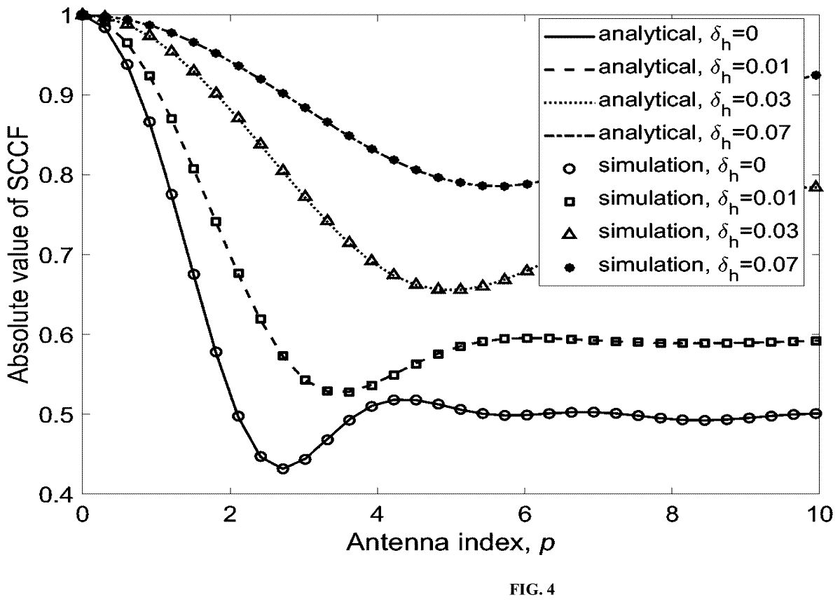

The spatial correlation between the transmitting antennas is studied under different wall roughness, and the result for the spatial correlation is as illustrated in FIG. 4. Similar to the time correlation function, as the wall roughness increases, the absolute value for the spatial correlation function eventually tends to 1. Furthermore, the fluctuation region of the spatial correlation function is extended with the increase of the wall roughness.

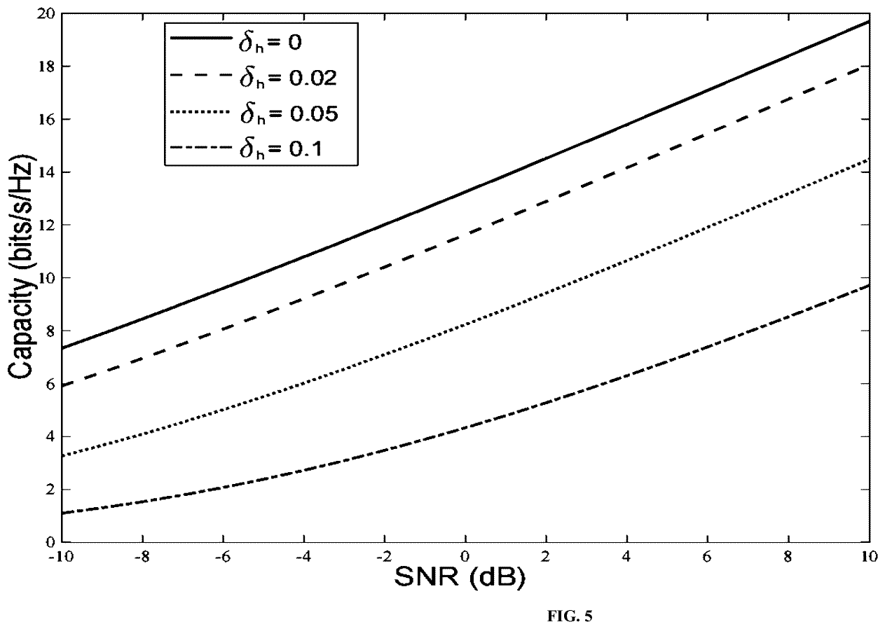

The channel capacity is studies under different wall roughness, and the simulation result for the channel capacity is as illustrated in FIG. 5. Compared with the smooth wall, the channel capacity is significantly reduced when the wall is rough. Furthermore, as the wall roughness increase, the channel capacity decreases.

To sum up, the underground mine channel model established by the present disclosure adopts the geometry-based stochastic channel modeling method, and considers the unique channel characteristics of the rough wall, and has a relatively high accuracy, a moderate complexity and a better universality, enriching the modeling method oriented to the underground mine channel, and the statistical characteristic of the simulation has a reference value for the design for the underground mine communication system.

The contents that are not described in detail in the present disclosure is a well-known technology for those skilled in the art. The preferred embodiments of the present disclosure are described in detail above. It should be understood that those skilled in the art can make various modifications and variations based on the concept of the present disclosure without creative efforts. Therefore, any technical solutions that can be obtained by those skilled in the art through the logical analysis, the reasoning or the limited experiments based on the concept of the present disclosure and on the basis of the existing technology should be within the protection scope determined by the claims.

What is claimed is:

1. A geometry-based stochastic channel modeling method oriented to a wireless communication in an underground mine, comprising following steps:
Step S1, generating basic parameters for an environment and antennas;
Step S2, generating a three-dimensional time-varying twin-cluster channel environment, specifically including positions of the clusters and angle parameters, distance parameters, and power parameters for scatterers;
Step S3, introducing a wall roughness, and characterizing, according to the angle parameters, an influence caused by a rough wall from two aspects of a phase variation and an energy attenuation;
Step S4, calculating a time-varying channel impulse response and a channel matrix, wherein the time-varying channel impulse response includes a line-of-sight (LoS) component and a non-LoS (NLoS) component; and
Step S5, calculating and obtaining, according to the channel matrix established in Step S4, a space-time-frequency correlation function and a channel capacity.

2. The geometry-based stochastic channel modeling method oriented to the wireless communication in the underground mine according to claim 1, wherein Step S1 specifically includes following steps:
determining large-scale fading parameters for the channel based on a frequency band, antenna parameters and a simulation time required for a scenario of the underground mine, wherein the basic parameters includes the frequency band, the antenna parameters, and the simulation time required for the scenario of the underground mine, and the large-scale fading parameters includes a path loss and a shadow fading.

3. The geometry-based stochastic channel modeling method oriented to the wireless communication in the underground mine according to claim 2, wherein Step S2 specifically includes following steps:
Step S201, adopting a twin-cluster channel model, wherein a uniform linear array is adopted for antennas at transmitter, and the antennas at transmitter are arbitrarily placed in a three-dimensional space;
Step S202, generating the positions of the clusters, wherein a cluster distance d̅, a horizontal angle ϕ̅_{A} and an elevation angle ϕ̅_{E} obey following distributions:
$$\overline{d} ∼ N ( u , σ )$$
$${\overline{ϕ}}_{A} = ASA * N ( 0 , 1 ) + {β}_{A}^{T}$$
$${\overline{ϕ}}_{E} = ESA * N ( 0 , 1 ) + {β}_{E}^{T} ,$$
where (d̅, ϕ̅_{A}, ϕ̅_{E}) denotes a spherical coordinate of the cluster, N(μ, σ) denotes a Gaussian distribution with a mean value of μ and a variance of σ, ASA and ESA denote standard documents of 3GPP, β_{A}^{T} denotes a horizontal angel of a placed antenna at transmitter, and β_{E}^{T} denotes an evaluation angle of the placed antenna at transmitter;
Step S203, generating positions of the scatterers, modeling a scatterer distribution in the cluster as a Gaussian ellipsoid distribution, and describing, through a cluster angular spread σ_{AS}, a cluster elevation spread σ_{ES} and a cluster delay spread σ_{DS}, the scatterer distribution, wherein the scatterers are in a rectangular coordinate system with a cluster center as a coordinate origin, and a distribution probability p(x′, y′, z′) of the scatterers located at (x′, y′, z′) is:
$$p ( {x}^{′} , {y}^{′} , {z}^{′} ) = \frac{exp ( - \frac{{x}^{′ 2}}{2 {σ}_{DS}^{2}} - \frac{{y}^{′ 2}}{2 {σ}_{AS}^{2}} - \frac{{z}^{′ 2}}{2 {σ}_{ES}^{2}} )}{{( 2 π )}^{3 / 2} {σ}_{DS} {σ}_{AS} {σ}_{ES}} ;$$
Step 204, deriving the power of the scatterer, specifically determining a position (dₘ_{ₙ}^{T}, ∅_{A,m}_{ₙ}^{T}, ∅_{E,m}_{ₙ}^{T}) of the scatterer in the three-dimensional space based on the distribution probability of the scatterer, wherein a propagation time delay corresponding to a m-th scatter in a n-th cluster, that is, the propagation time delay τ_{qp,m}_{ₙ}(t) corresponding to a mₙ-th sub-path is:
$${τ}_{pq , {m}_{n}} ( t ) = \frac{{d}_{pq , {m}_{n}} ( t )}{c} + {\tilde{τ}}_{{m}_{n}} ,$$
where d_{pq,m}_{ₙ}(t) denotes a transmission distance of the mₙ-th sub-path, \tilde{τ}ₘ_{ₙ} denotes a time delay at a virtual link, which obeys an exponential distribution, d_{pq,m}_{ₙ}(t) is calculated by a formula of d_{pq,m}_{ₙ}(t)=∥\vec{d}_{p,m}_{ₙ}^{T}(t)∥+∥\vec{d}_{q,m}_{ₙ}^{R}(t)∥, ∥\vec{d}_{p,m}_{ₙ}^{T}(t)∥ denotes a transmission distance from a p-th antenna at transmitter to the m-th scatterer in the n-th cluster, ∥\vec{d}_{q,m}_{ₙ}^{R}(t)∥ denotes a transmission distance from a q-th antenna at receiver to the m-th scatterer in the n-th cluster, a superscript arrow “→” denotes a vector, and “∥*∥” denotes a norm;
under a condition of a broad-balanced plane wave, ∥\vec{d}_{p,m}_{ₙ}^{T}(t)∥ is calculated by a formula of ∥\vec{d}_{p,m}_{ₙ}^{T}(t)∥=d_{p,m}_{ₙ}^{T}(t)≈dₘ_{ₙ}^{T}−cos(ϑ^{T}ₘ_{ₙ})δₚ−cos(ω^{T}ₘ_{ₙ})ν^{T}(t)t, dₘ_{ₙ}^{T} denotes a transmission distance from a first antenna at transmitter to the m-th scatterer in the n-th cluster, δₚ denotes a spacing between the antennas at transmitter, ϑ^{T}ₘ_{ₙ} denotes an included angle between a transmitting antenna array and the mₙ-th sub-path of the first antenna at transmitter, ω^{T}ₘ_{ₙ} denotes an included angel between a motion direction of the transmitter and the mₙ-th sub-path emitted from the p-th antenna at transmitter, cos(ϑ^{T}ₘ_{ₙ}) is calculated by a formula of cos(ϑ^{T}ₘ_{ₙ})=cos(∅_{E,m}_{ₙ}^{T})cos(β_{E}^{T})cos(β_{A}^{T}−∅_{A,m}_{ₙ}^{T})+sin(∅_{E,m}_{ₙ}^{T})sin(β_{E}^{T}), and cos(ω^{T}ₘ_{ₙ}) is calculated by a formula of cos(ω^{T}ₘ_{ₙ})=cos(α^{T}−∅_{A,m}_{ₙ}^{T})cos(∅_{E,m}_{ₙ}^{T}), ∅_{A,m}_{ₙ}^{T} denotes a horizontal departure angle corresponding to the mₙ-th sub-path, ∅_{E,m}_{ₙ}^{T} denotes an elevation departure angle corresponding to the mₙ-th sub-path, β_{A}^{T} denotes a horizontal angle of the placed transmitting antenna, and β_{E}^{T} denotes an elevation angle of the placed transmitting antenna;
assuming that the antenna at transmitter are motioned in a xoy plane, then ν^{T}(t) denotes a motion velocity of the antenna at transmitter, and α^{T} denotes a motion direction;
a power distribution P′_{pq,m}_{ₙ}(t) of a sub-path in the cluster is:
$${P}_{pq , {m}_{n}}^{′} ( t ) = exp ( - {τ}_{pq , {m}_{n}} ( t ) \frac{{r}_{τ} - 1}{{r}_{τ} DS} ) 1 {0}^{- \frac{{Z}_{n}}{10}} \cdot {ξ}_{n} ( p , q ) ,$$
where DS denotes a time delay spread, r_{τ} denotes a factor of a time delay distribution proportionality, the two parameters of DS and r_{τ} are given by the 3GPP standardized document, Zₙ denotes a Gaussian random variable with a mean value of 0, and ξₙ(p, q) denotes a variation coefficient of a power of the cluster along the array; and
Step S205, normalizing the power distribution P′_{pq,m}_{ₙ}(t) of the sub-path in the cluster, wherein the P′_{pq,m}_{ₙ}(t) is calculated by a formula of
$${P}_{pq , {m}_{n}} ( t ) = {P}_{pq , {m}_{n}}^{′} ( t ) / {\sum }_{n = 1}^{{N}_{pq} ( t )} {\sum }_{m = 1}^{{M}_{n} ( t )} {P}_{pq , {m}_{n}}^{′} ( t ) ,$$
where N_{pq}(t) denotes a number of clusters passing between the p-th antenna at transmitter and the q-th antenna at receiver, and Mₙ(t) denotes a number of scatterers in the cluster.

4. The geometry-based stochastic channel modeling method oriented to the wireless communication in the underground mine according to claim 3, wherein assuming that the wall roughness, that is, a height difference between a rough surface and a smooth surface is Δh, and the height difference Δh obeys the Gaussian distribution with the mean value of 0, and a standard difference is δₕ, that is, Δh˜N(0, δh2), compared with a smooth surface, a phase difference Δφ caused by the rough surface is:
$$Δφ = 2 k Δ h sin α ,$$
where
$$k = \frac{2 π}{λ}$$
denotes a wave number, α denotes an included angle between an incident ray and a horizontal plane;
in addition, a loss of a signal energy is further caused by the rough surface, and a roughness attenuation factor ρₛ caused by the rough surface is:
$${ρ}_{s} = exp \{ - 8 {( \frac{π {δ}_{h} cos θ}{λ} )}^{2} \} ,$$
where θ denotes an included angle between the incident ray and a surface normal.

5. The geometry-based stochastic channel modeling method oriented to the wireless communication in the underground mine according to claim 4, wherein in Step S4, the channel matrix H is expressed as:
$$H = {[ {h}_{pq} ( t , τ ) ]}_{{m}_{T} \times {m}_{R}} ,$$
where m_{T} denotes a number of the antennas at transmitter, m_{R} denotes a number of the antennas at receiver, h_{pq}^{N}(t, τ) denotes a time-varying channel impulse response, and an expression of h_{pq}^{N}(t, τ) is:
$${h}_{p q} ( t , τ ) = \sqrt{\frac{K}{K + 1}} {h}_{pq}^{L} ( t , τ ) + \sqrt{\frac{1}{K + 1}} {h}_{pq}^{N} ( t , τ ) ,$$
where, K denotes a Rice factor, h_{pq}^{L}(t, τ) denotes a LoS component, and h_{pq}^{N}(t, τ) denotes a NLoS component;
an expression of the LoS component h_{pq}^{L}(t, τ) is:
$${h}_{pq}^{L} ( t , τ ) = {e}^{j 2 π {f}_{c} {τ}_{pq}^{L} ( t )} \cdot δ ( τ - {τ}_{pq}^{L} ( t ) ) ,$$
expressions of the NLoS component h_{pq}^{N}(t, τ) are:
$${h}_{pq}^{N} ( t , τ ) = {\sum }_{n = 1}^{{N}_{pq} ( t )} {\sum }_{m = 1}^{{M}_{n} ( t )} {h}_{pq , {m}_{n}}^{N} ( t , τ )$$
$${h}_{pq , {m}_{n}}^{N} ( t , τ ) = \sqrt{{P}_{pq , {m}_{n}} ( t )} {e}^{j 2 π {f}_{c} {τ}_{pq , {m}_{n} ( t )}} \cdot δ ( τ - {τ}_{pq , {m}_{n}} ( t ) ) ,$$
where Aₚ^{T} denotes the p-th antenna at transmitter, A_{q}^{R} denotes a q-th antenna at receiver, f_{c} denotes a carrier frequency, τ_{pq}^{L}(t) denotes a time delay at a LoS path between Aₚ^{T} and A_{q}^{R}, N_{pq}(t) denotes a number of clusters of a path between Aₚ^{T} and A_{q}^{R}, and Mₙ(t) denotes a number of scatterers in the n-th cluster;
τ_{pq,m}_{ₙ}(t) denotes a time delay of the mₙ-th sub-path, and P_{pq,m}_{ₙ}(t) denotes a power of a m-th scatterer in the n-th cluster between Aₚ^{T} and A_{q}^{R};
when the wall surface is rough, a LoS component is not reflected through the rough surface, so the channel impulse response of the LoS component remains unvaried; for an arbitrary ray of NLoS paths, assuming that the ray experiences reflections for kₘ_{ₙ} times, the phase difference caused by the rough surface is
$${Δφ}_{{m}_{n}} = {Δφ}_{1} + {Δφ}_{2} + … + {Δφ}_{{k}_{{m}_{n}}} ,$$
and an attenuation of the signal energy is
$${ρ}_{s}^{{k}_{{m}_{n}}} ,$$
therefore the channel impulse response of the NLos component is modified as
$${h}_{pq , {m}_{n} ( new )}^{N} ( t , τ ) = {h}_{pq , {m}_{n}}^{N} ( t , τ ) \cdot {e}^{- j Δ {φ}_{{m}_{n}}} \cdot {ρ}_{s}^{{k}_{{m}_{n}}} .$$

6. The geometry-based stochastic channel modeling method oriented to the wireless communication of the underground mine according to claim 5, wherein Step S5 specifically includes:
the time-varying channel impulse response h_{pq}(t, τ) is transformed through a Fourier transform to obtain a channel transmission function, the channel transmission function is expressed as H(t, f)=∫₀^{∞}h(t, τ)e^{-j2πfτ}dτ, and the space-time-frequency correlation function is further expressed as:
$${R}_{pq , \tilde{p} \tilde{q}} ( t , f ; Δ r , Δ t , Δ f ) = E \{ {H}_{pq} ( t , f ) {H}_{\tilde{p} \tilde{q}}^{T} ( t - Δ t , f - Δ f ) \} ,$$
where E{⋅} denotes an expectation, {⋅}^{T} denotes a transposition, H_{pq}(t, f) denotes a channel transmission function between the p-th antenna at transmitter and the q-th antenna at receiver, and Δr, Δt, Δf are interval parameters in space, time, and frequency domains;
the channel capacity C is:
$$C = E \{ {log}_{2} ( 1 + \frac{ρ}{{m}_{T}} H {H}^{*} ) \} ,$$
where ρ denotes a signal-to-noise ratio, and {⋅}* denotes a conjugate transposition.
